(19) United States
(12) Patent Application Publication
(10) Pub. No.: US 2006/0167765 A1
(43) Pub. Date: Jul. 27, 2006

(54) Methods of online fund raising over a network

(76) Inventors: Dominic James Lacey, Great Chesterford (GB); Will Hardy, Newbury (GB); Richard Marr, London (GB); Jason Horton, London (GB)

Correspondence Address: J. SCOTT SOUTHWORTH ATTORNEY AT LAW, P.O. BOX 1287, FRAMINGHAM, MA, 01701, US

(21) Appl. No.: 11/328,883

(22) Filed: Jan. 10, 2006

Related U.S. Application Data
(60) Provisional application No. 60/643,178, filed on Jan. 12, 2005.

(51) Int. Cl. G06Q 30/00

(52) U.S. Cl. 705/26

(57) ABSTRACT

A method for generating a page for charitable fund raising over a network. A user creates a definition for a fund raising event and transfers the definition to a fund raising server, which generates event information (e.g., an event record). The user selects a non-profit organization and transfers the selection to the fund raising server, which generates organization information (e.g., organization record). The fund raising server generates a mapping (e.g., mapping record) of the event information to the organization information. The fund raising server creates a fund raising page accessible over the network based on input from the user and providing a link from the fund raising page to the mapping. The user is also able to nominate a non-profit organization which is not yet available for selection, which is then vetted by the fund raising server.

### RELATED APPLICATION

This application claims the benefit of U.S. Provisional Patent Application No. 60/643,178, entitled “Methods of Online Fundraising,” filed on Jan. 12, 2005, the entire teachings of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Professional solicitors operate through the Internet to encourage donations to nonprofit charitable organizations. Typically, professionals employed or associated with such nonprofit organizations are involved in determining and setting up one or more Web pages for their organizations, including solicitation text. In many cases, the professional sets up a Web page tied to some previously planned event associated with the organization, such as an annual running event sponsored by the organization.

### SUMMARY OF THE INVENTION

In one aspect, the invention features a method for generating a page for charitable fund raising over a network at a fund raising server. The method includes generating event information based on receiving from a user computing device a definition for a fund raising event created by a user; determining organization information based on receiving from the user computing device a selection of a non-profit organization determined by the user; generating a mapping of the event information to the organization information; and creating a fund raising page accessible over the network based on user input and based on providing a link from the fund raising page to the mapping.

In one embodiment, the event information is an event record, the organization information is an organization record, and the mapping is a mapping record.

In another embodiment, the method includes receiving a nomination for the selected nonprofit organization provided by the user and vetting the nonprofit organization based on the nomination.

The method includes, in another embodiment, vetting an address for the selected nonprofit organization to insure delivery of event contributions to the selected nonprofit organization.

In another aspect, the invention features a method for generating a charitable fund raising page at a user computing device by a user over a network. The method includes providing a definition for a fund raising event by the user at a user computing device to generate event information at a fund raising server; providing a selection of a non-profit organization determined by the user at the user computing device to determine organization information at the fund raising server; and providing user input to the fund raising server to generate a fund raising page accessible over the network based on a link from the fund raising page to a mapping of the event information to the organization information generated at the fund raising server.

In one embodiment, the event information is an event record, the organization information is an organization record; and the mapping is a mapping record.

In another embodiment, the method includes providing a nomination for the selected nonprofit organization for vetting by the fund raising server to determine the organization information.

The organization information, in another embodiment, includes an address for the selected non-profit organization for vetting by the fund raising server to insure delivery of event contributions to the selected nonprofit organization.

In another aspect, the invention features a method for processing a destination address for charitable fund raising over a network by a fund raising server and for access at a requesting computing device by a requestor providing the destination address. The method includes receiving at the fund raising server a page-not-found error for the destination address provided by the requestor; accessing a database of page information to locate a destination page based on receiving the page-not-found error; and creating a fund raising page for display at the requesting computer device to the requestor over the network from the fund raising server corresponding to the destination address based on the located destination page.

In one embodiment, the page-not-found error comprises a hypertext transfer protocol not-found status code.

### DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a schematic diagram of a fund raising system, in accordance with the principles of the invention.

FIG. 2 is a flowchart of a fund raising page creation procedure, according to the principles of the invention.

FIG. 3 is a block diagram of linking relationships among fund raising records, in accordance with the principles of the invention.

FIGS. 4A, 4B, 4C, 4D, and 4E are flowcharts of an event and charity selection procedure, in accordance with the principles of the invention.

FIG. 5 is a schematic diagram of a destination address processing system, according to the principles of the invention.

FIG. 6 is a flowchart of an address processing procedure, according to the principles of the invention.

### DETAILED DESCRIPTION

In brief overview, the present invention relates to methods and systems that enable a user to create a fund raising page over a network (e.g., the Internet), who typically is not affiliated with the charitable organization benefiting from the fund raising page. Users of the invention can create their own event and select charitable organizations to benefit from the event. Users can also nominate a charitable organization that is not in the system's database of charitable organizations. The approach of the invention is also able to vet the nominated organization to confirm that it is a legitimate charitable organization and verify an address to receive donations.

After accessing the system of the invention over a network (e.g., Internet), an individual (e.g., user) creates a Web page for fund raising or philanthropic solicitation. The individual visits a Web site configured according to the invention and either selects an “event” from a database or provides information for the event. This event can be a personal occasion, such as a birthday, or a public event, such as a marathon. The user then selects a not-for-profit organization (NPO) from a database, configured according to the invention. If the user can not find a NPO that the user would like to raise funds for, the user can submit (i.e. nominate) an organization of choice for entry in the database.

In a conventional approach, online fundraising tools typically restrict the fund-raiser to a predetermined list of available events. In contrast, the approach of the invention enables fund-raisers (e.g., users of the system of the invention who are not typically employees of the benefiting NPO) to create and define their own event for fundraising. Fund-raisers can either search for an organized event and then create a personal fundraising page (PFP) for that event, or fund-raisers name their own event, event date and category (e.g. running, cycling, or swimming). The event date is used to determine page expiry. The event name is used for display on the PFP. The event category is used to control the design and copy (e.g., text) of the resulting PFP page.

When a fund-raiser names and defines an event, a new event record is created in the database according to the principles of the invention. That event record is then linked (i.e., mapped) to the appropriate charity record, and the resulting new PFP record is linked to the linking (i.e., mapping) record between the event and the charity.

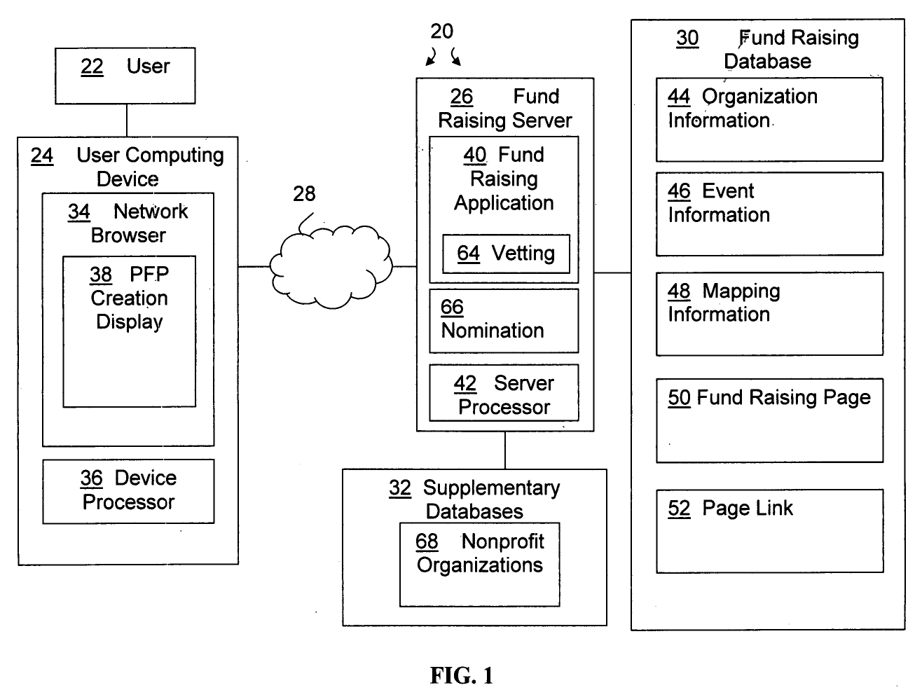

FIG. 1 is a schematic diagram of a fund raising system 20, in accordance with the principles of the invention. FIG. 1 illustrates a user computing device 24 connected by a network 28 to a fund raising server 26, which is associated with a fund raising database 30 and can be associated with other supplementary databases 32.

A user 22, who is seeking to create a personal fund raising page (PFP) 50, accesses the user computing device 24, which is an electronic device having computing capabilities, such as a desktop computer, a laptop computer, a palmtop computer, a PDA (personal digital assistant), a mobile communications device (e.g., cell phone), a hybrid device (e.g., a device including both mobile communications and digital computing capabilities) and other suitable devices. The user computing device 24 includcs user input devices (e.g., keyboard and mouse), one or more output devices (e.g., LCD display or CRT display), data storage (e.g., volatile memory or nonvolatile data storage), and a device processor 36 (e.g., digital microprocessor). The user computing device 24 has the capability of presenting a PFP creation display 38 using a network browser 34 on the output display. The device processor 36 executes software instructions for the network browser 34 and the PFP creation display 38 that are stored in the data storage of the user computer 24 and/or downloaded from the fund raising server 26 to perform the functions of the PFP creation display 38 as described herein. The PFP creation display 38 is a display of page creation questions and information provided to the user 22, after the user 22 has made a request to view a display for creating a PFP 50. In one embodiment, the PFP creation display 38 is a Web page displayed in a network browser 34 (e.g., an Internet browser).

The fund raising server 26 is a server computer, desktop computer, or other digital computing device suitable for executing the fund raising application 40. The PFP creation display 38 is a presentation of PFP creation information provided and maintained by the fund raising application 40. The fund raising server 26 includes a server processor 42 (e.g., digital microprocessor) that executes software instructions for the fund raising application software 40 to perform the functions of the fund raising application 40 as described herein. In one embodiment, the functions of the fund raising server 26 are handled by a network of multiple servers 26 with appropriate coordination, such as load balancing, among the servers. The PFP creation display 38 is not required by the invention to be a Web page, accessed over the Internet using the IP (Internet Protocol), but can be based on other suitable types of user interface (UI) and display software protocols and technologies capable of providing a PFP creation display 38 (e.g., displayed Web site) to a user 22 at the user computing device 24. Accordingly, the PFP creation display 38 is not required to be based on any specific presentation protocol (e.g., based on HTML (hypertext markup language)), but can be based on other forms of UI and/or presentation software. The PFP creation display 38 can also be based on UI, presentation software, network protocols, and related software and technologies to be developed in the future.

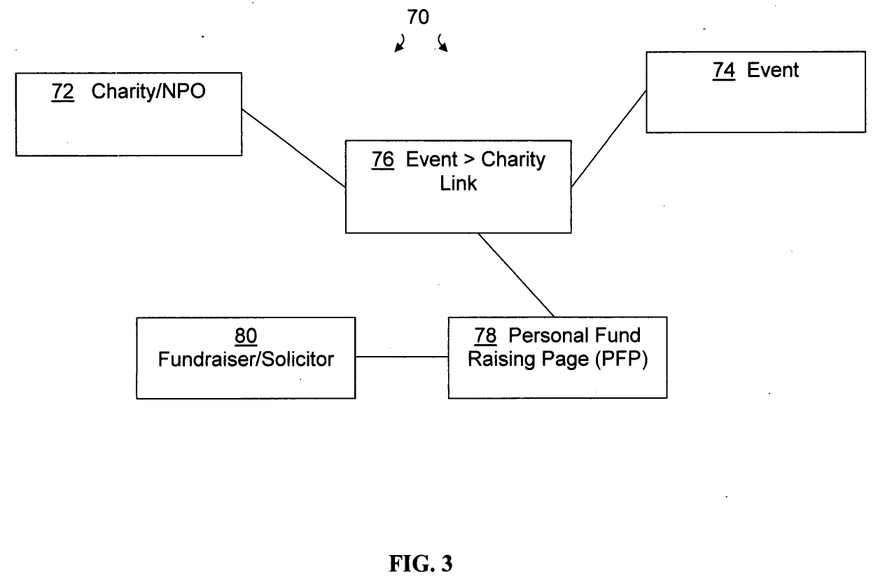

The fund raising (FR) database 30 is a database maintained on a data storage device storing digital data suitable for use by the fund raising server 26. The fund raising database 30 is associated with the fund raising server 26, and can be contained in the same physical box (e.g., cabinet), attached by a dedicated cable, or accessible over a network, such as the Internet or another network, such as an SAN (storage area network). The FR database 30 is stored on a hard disk drive, read-write integrated circuit (IC) memory chips, or one or more other suitable digital data storage devices. The FR database 30 includes organization information (e.g., data for charitable nonprofit organizations (NPO)), event information (e.g., data for fund raising events), mapping information (e.g., mappings or linkings between organizations and events), fund raising page (e.g., data and/or code for PFP's), and page link information (e.g., links between PFP's and other information, see, for example, FIG. 3). For each category of information (44, 46, 48, 50, 52), the FR database 30 includes one or more entries (e.g., records) in the database 30.

The supplementary databases 32 are one or more databases maintained on one or more data storage devices storing digital data suitable for use by the fund raising server 26. The databases 32 typically include information and data, such as information on charitable organizations and NPO's 68 not yet included in the organization information 44. The databases 32 can be contained in the same physical box (e.g., cabinet), attached by a dedicated cable, or accessible over a network, such as the Internet or an SAN (storage area network). The databases 32 are stored on a hard disk drive, read-write memory chips, or other suitable digital data storage device. The databases 32 can be maintained by a governmental organization, such as government database of NPO's 68 approved by a national government as charitable organizations. Furthermore, the databases 32 can be one or more databases maintained by a third-party organization including information and data derived from or based on a governmental organization (e.g., government approved charitable organizations 68). The fund raising application 40 includes a vetting module 64 that confirms a nomination 66 of a NPO as a legitimate charitable NPO by accessing the nonprofit organization information 68 in one or more of the databases 32. The databases 32 can also include other types of supplementary information and data that prove useful to the fund raising application 40, such as events (e.g., sporting events) not yet associated with a NPO. Events can also be personal occasions, such as birthdays, anniversaries, and other suitable personal events.

The network 28 is a communications network suitable for providing a connection between the user computing device 24 and fund raising server 26. The network 28 can be the Internet, LAN (local area network), WAN (wide area network), SAN (storage area network), MAN (metropolitan area network), a wireless network (e.g., Bluetooth or IEEE 802.11), a mobile communications network, (e.g., cellular network based on CDMA (code division multiple access)), or other suitable network, as well as network, communications, technologies, and protocols to be developed in the future.

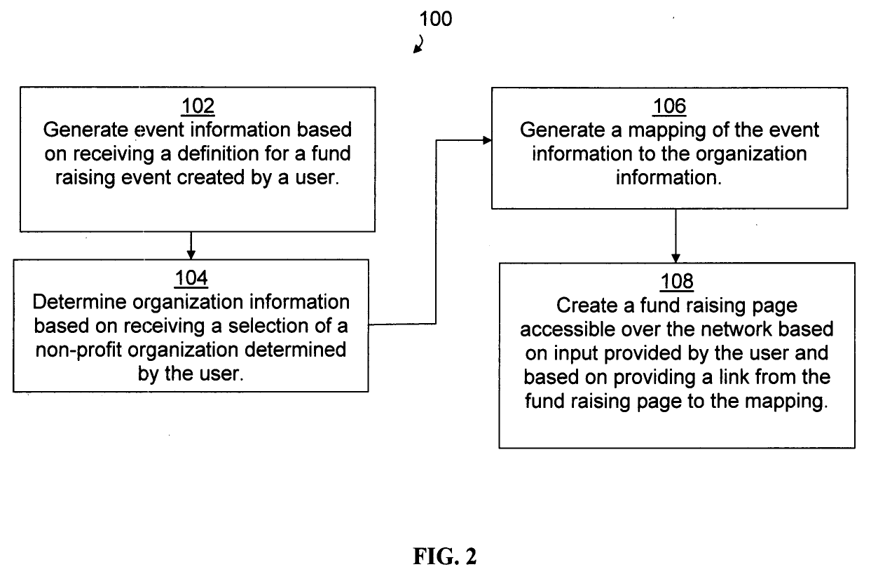

FIG. 2 is a flowchart of a fund raising page creation procedure 100, according to the principles of the invention. First, the procedure 100 generates event information 46 after receiving a definition for a fund raising event created by a user 22 (step 102). For example, the fund raising server 26 receives a definition for a fund raising event received when a user 22 provides input into the PFP creation display 38 presented on an output device at the user computing device 24. The user computing device 24 transfers this definition over the network 28 to the fund raising server 26, which stores the definition as event information 46 in the fund raising database 30. The event information 46 can include one or more entries (e.g., records) for one or more event definitions.

Next the procedure 100 determines organization information 44 after receiving a selection of a non-profit organization (NPO) determined by the user 22 (step 104). For example, the user 22 selects an NPO by providing input to the PFP creation display 38 presented at an output device on the user computing device 24. The user computing device 24 transfers this NPO selection over the network 28 to the fund raising server 26, which stores the selection as organization information 44 in the fund raising database 30. The organization information 44 can include one or more entries (e.g., records) for one or more NPO's.

The procedure 100 then generates a mapping 48 (also termed a “linking”) of the event information 46 to the organization information 44 (step 106). For example, the fund raising server 26 creates a mapping link (e.g., record) that maps a specific event chosen or created by the user 22 to a specific NPO selected by the user 22, and stores this mapping as mapping information 48 in the fund raising database 30. The mapping information 48 can include one or more entries.

Then, the procedure 100 creates a fund raising page (PFP) 50 accessible over the network 28 based on input provided by the user 22 and based on providing a link 52 from the fund raising page 50 to the mapping 48. For example, the fund raising server 26 creates a PFP 50 based on input for a specific PFP provided by the user 22 to the PFP creation display 38 presented on an output device at the user computing device 24, as described in more detail elsewhere herein. The PFP 50 is based on the organization information 44, event information 46, and mapping information 48 provided by the user 22, and other related information. The user 22 can provide user input for the user's PFP 50, such as a logo and/or one or more photographs (e.g., image file such as a jpg, gif, psd or other file). For example, the user input can include a photograph of runners for a running event. The user input can also include style and appearance information, such as banner design, footer design, background color, and other features. In other embodiments, the user input can include font size and style information, various media (e.g., animation, video, audio, and other suitable media), custom placement and design of header, banners, and footers, and other input suitable for Web page design. The fund raising server 26 creates a link between the fund raising page 50 and the mapping 48, and stores the page link 52 in the fund raising database 30. The FR database 30 can include one or more page links 52. In one embodiment, the user 22 receives a confirmation of the creation of the PFP 50 at the user computing device 24.

The user 22 can also nominate an NPO to be included in the fund raising database 30. A vetting module 64 (an object, program, procedure, or other software entity) examines the nomination 66 to determine if the NPO is a legitimate charitable organization. For example, the vetting module 64 checks in the supplementary database 32 to determine if the nomination 66 is listed as a government approved charitable nonprofit organization 68. The vetting module 64 can also verify the address of the nomination 66, so that donations are sent to a confirmed address for receiving donations at the nonprofit organization 68. After this process, the fund raising server 26 can add the vetted nonprofit organization 68 to the organization information 44 maintained in the fund raising database 30.

FIG. 3 is a block diagram of linking relationships 70 among a charity/NPO (nonprofit organization) record 72, event record 74, and fund raising page record 78, in accordance with the principles of the invention. An [Event>Charity] linking entity 76 is created in real-time when a fund-raiser (e.g., user 22) creates a PFP record 78. The event charity link record 76 serves as a mapping between the charity/NPO record 72 and the event record 74. In practice the approach of the invention, as indicated in FIG. 3, removes a limitation on the individual context of each fund-raiser's (e.g., user's 22) fundraising. Thus, fund-raisers are not restricted to a predetermined list of fund raising events.

The event charity link record 76 is linked to the fund raising page record 78, which is associated with a fund-raiser/solicitor record 80, for a specific user 22 of the user computing device 24. The user 22 provides an organization selection for the charity/NPO record 72, chooses or creates an event for the event record 74, and indicates a mapping between the two records (72, 74) which is indicated in the event charity link record 76. In one embodiment, the charity/NPO record 72 is an embodiment of organization information 44, the event record 74 is an embodiment of event information 46, and the event charity link record 76 is an embodiment of mapping information 48, and the fund raising page record 78 is an embodiment of PFP information 50.

The following sample code supports the real-time creation of an event record 74:

```
  Dim oEvent  As Entity
  Set oEvent = voActivity.GetEntityManager(“Event”).CreateEntity(True)
  With oEvent
    .SetAttributeValue “EventName”, vsEventName
    .SetAttributeValue “IsOverseas”, vblsOverseas
    .SetAttributeValue “StartDate”, Now
    .SetAttributeValue “CompletionDate”, vdteEventCompletionDate
    .SetAttributeValue “GroupGivingCategoryId”, vlEventGroupGivingCategoryId
    If UCase$(vsGroupGivingCategoryType) = “EVENTS” Then
      .SetAttributeValue “ExpiryDate”, DateAdd(“m”, 2, vdteEventCompletionDate)
      .SetAttributeValue “PledgeReleaseDate”, DateAdd(“d”, 11, vdteEventCompletionDate)
    Else
      .SetAttributeValue “ExpiryDate”, vdteEventCompletionDate
      .SetAttributeValue “PledgeReleaseDate”, vdteEventCompletionDate
    End If
  End With
  Call oEvent.Save(voActivity)
  CreateEvent = oEvent.GetAttributeValue(“EventId”)
  Exit Function
End Function
Copyright © 2004 Firstgiving. Inc.
```

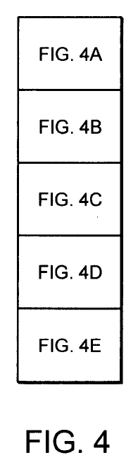

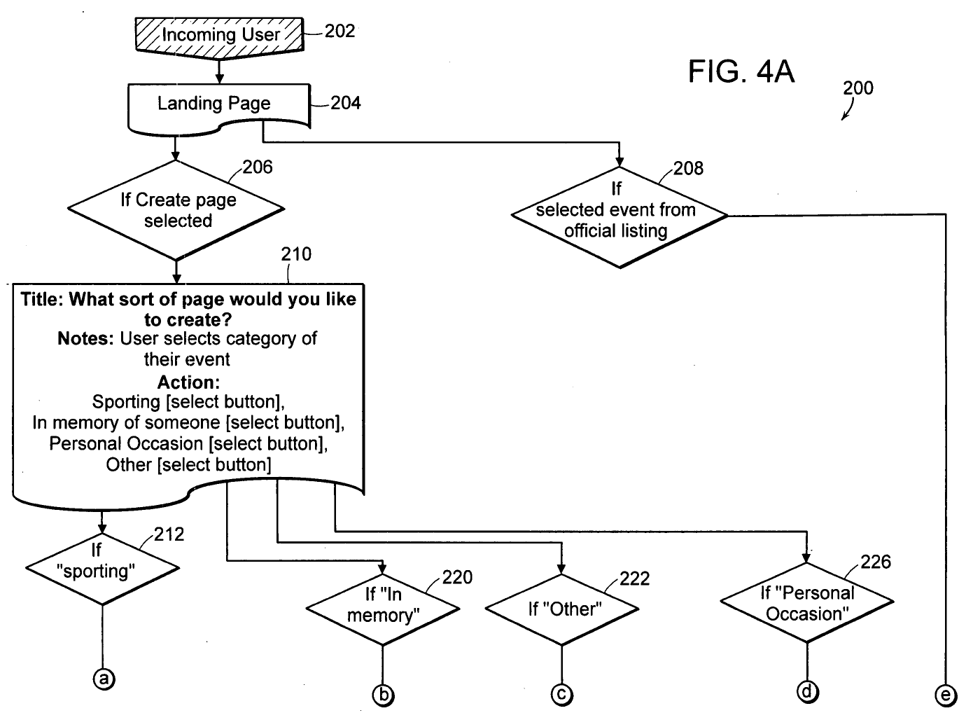

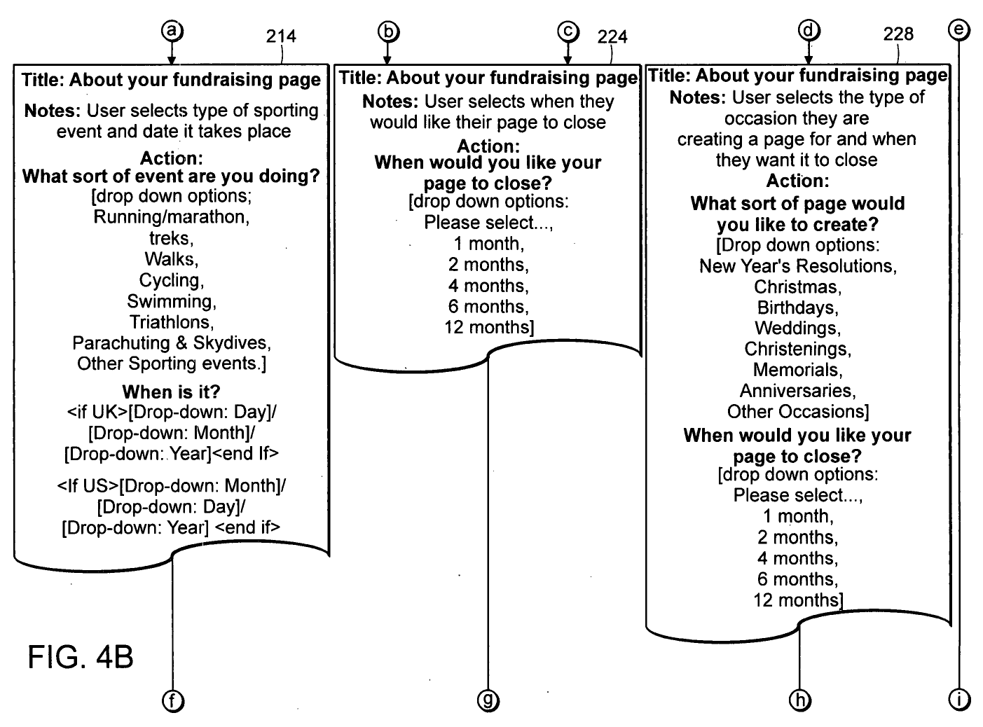

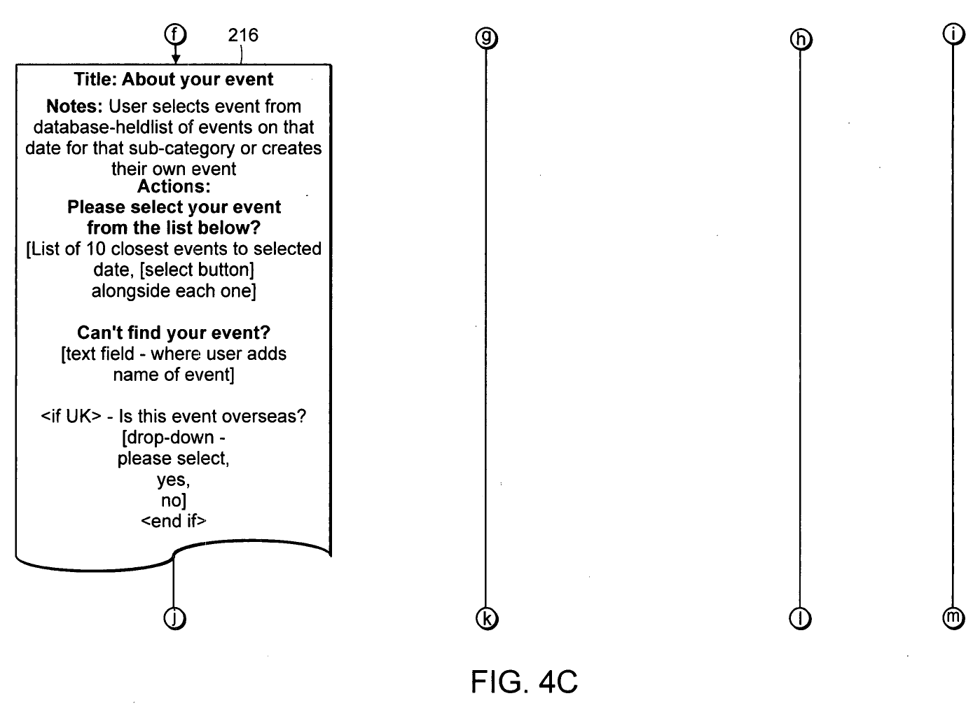

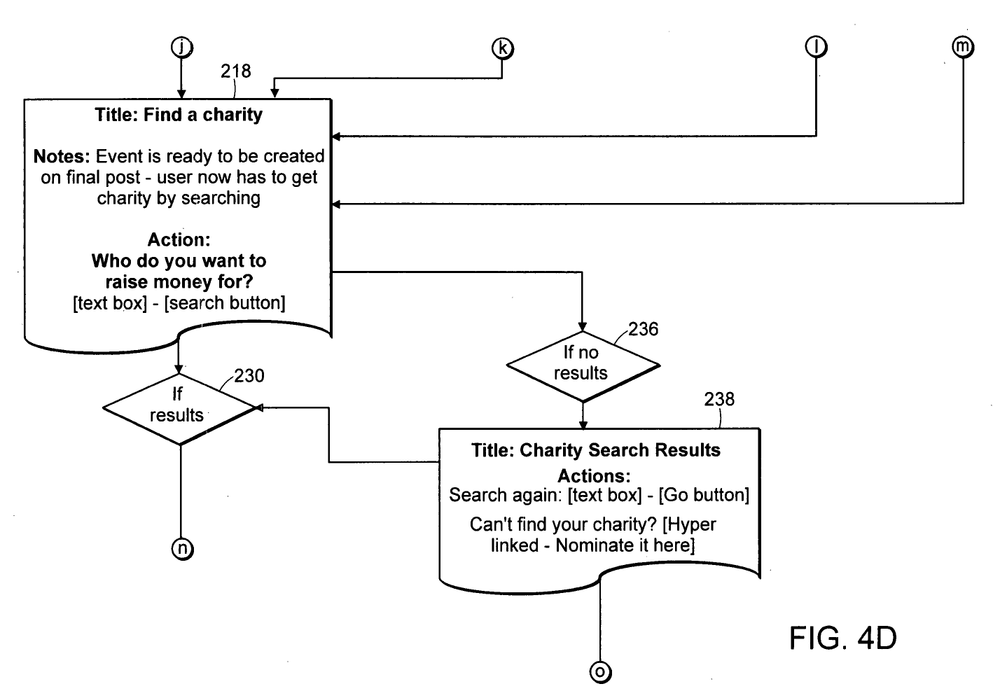

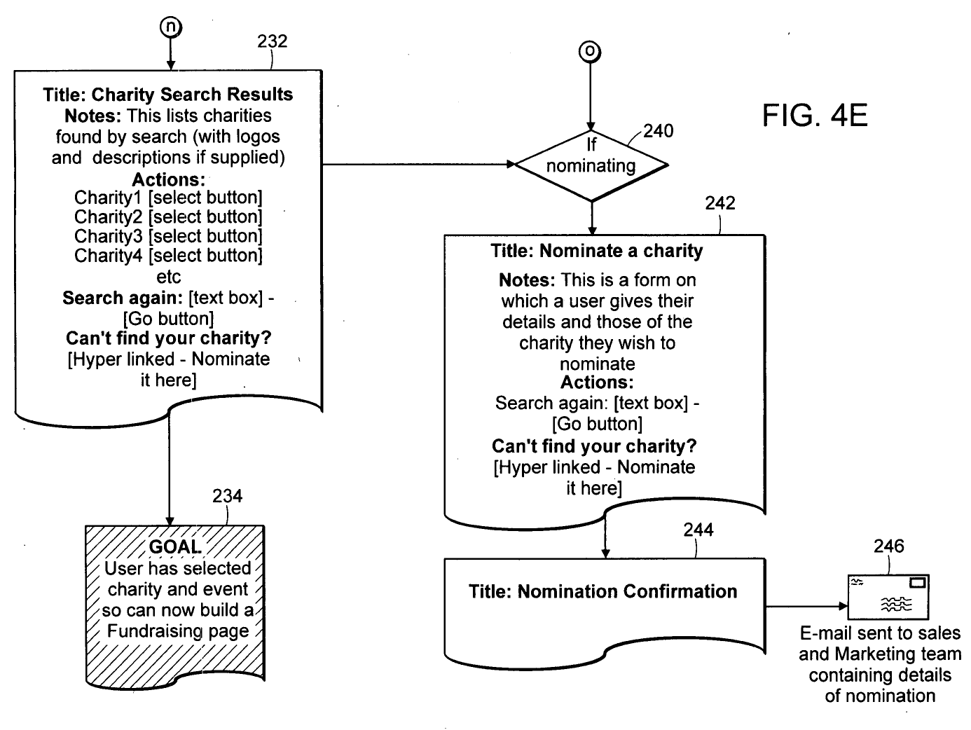

FIG. 4 (FIGS. 4A, 4B, 4C, 4D, and 4E) is a flowchart of an event and charity selection procedure 200, in accordance with the principles of the invention. The procedure 200 starts with an incoming user 22 (step 202), who accesses a landing page (e.g., PFP creation display 38) (step 204). The user 22 selects the creation of a PFP 50 (step 206) or selects an event from an official listing (e.g., previously created event) (step 208). If the user 22 selects creation of a PFP, then the procedure 200 asks what sort of page does the user 22 want to create and what category of event that the user 22 wishes to select (step 210). The user 22 can select sporting (step 212), “in memory of someone” (step 220), “other” (step 222), or personal occasion (step 226) categories. The approach of the invention is not limited to these categories (indicated by steps 212, 220, 222, and 226), and other categories can be used.

If the user 22 selects a sporting category (step 212), then the procedure 200 asks for information about the event, such as what sort of sporting event and when it is (steps 214 and 216). If the user 22 selects an “in memory” or “other” category (steps 220 or 222), then the procedure 200 asks when the user 22 wishes for the event to close (step 224). If the user 22 selects a personal occasion category (step 226), then the procedure 200 asks for information about the event (step 228).

The procedure 200 then asks the user 22 to find a charity (e.g., NPO) to associate with the event and conducts a search of NPO's 44 listed in the fund raising database 30 and/or supplementary databases 32 (step 218) If one or more NPO's 44 are found in the FR database 30, then the procedure 200 asks the user 22 to select an NPO or conduct further searching (steps 230, 232). If an NPO is selected, then the procedure 200 proceeds to build a PFP 50 using the input provided by the user 22 (step 234).

If no NPO's are found in the FR database 30 and/or supplementary databases 32, then the procedure 200 asks if the user 22 wants to search again or nominate a NPO that is not yet listed in the fund raising database 30 and/or supplementary databases 32 (steps 236, 238). If the user 22 provides a nomination 66, the procedure 200 asks for information about the nominated NPO and confirms the nomination 66 (steps 240, 242, 244, 246). The nomination process (step 240) can also be invoked during the searching process (step 232). Once a nomination has been confirmed (step 244), then a PFP 50 can be built using the input provided by the user 22.

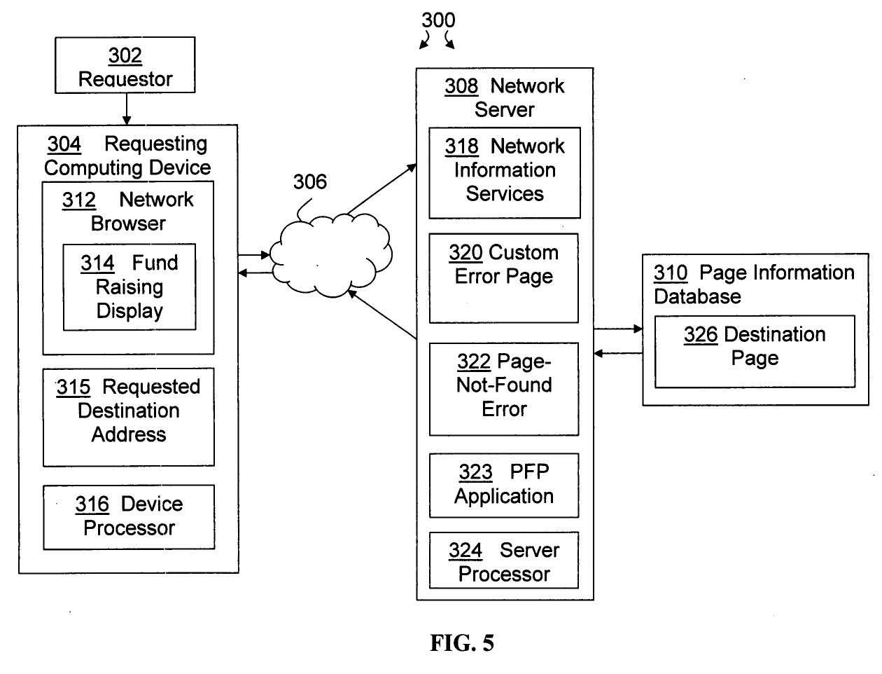

FIG. 5 is a schematic diagram of a destination address processing system 300, according to the principles of the invention. FIG. 5 illustrates a requesting computing device 304 connected by a network 306 to a network server 308, which is associated with a page information database 310.

A requestor 302, who is seeking to access an already created personal fund raising page (PFP), accesses the requesting computing device 304, which is an electronic device including computing capabilities, such as a desktop computer, a laptop computer, a palmtop computer, a PDA, a mobile communications device (e.g., cell phone), a hybrid device (e.g., a device including both mobile communications and digital computing capabilities) and other suitable devices. The requesting computing device 304 includes user input devices (e.g., keyboard and mouse), one or more output devices (e.g., LCD display or CRT display), data storage (e.g., volatile memory or nonvolatile data storage), and a device processor 316 (e.g., digital microprocessor). The requesting computing device 304 stores a requested destination address 315 provided by the requestor 302, which is stored in data storage at (or associated with) the requesting computing device 304. The requesting computing device 304 has the capability of presenting a fund raising display 314 (e.g., displayed PFP) using a network-browser 312 (e.g., Internet Web browser) presented on the output display of the requesting computing device 304. The device processor 316 executes software instructions for the network browser 312 and the fund raising display 314 that are stored in the data storage of the requesting computing device 304 and/or downloaded from the network server 308 to perform the functions of the fund raising display 314 as described herein.

The fund raising display 314 is a display of fund raising information provided to the requestor 302, after the requestor 302 has made a request to view a specific display of fund raising information. In one embodiment, the fund raising page 314 is a PFP Web page. The fund raising display 314 is based on the destination page 326, or a network address for a PFP provided by the data at the destination page 326 (e.g., network address indicating the location of the fund raising page 50). The fund raising display 314 is not required by the invention to be a Web site (e.g., based on HTML (hypertext markup language)), which is accessed over the Internet using the IP (Internet Protocol), but the fund raising display 314 can be based on other suitable types of user interface and display software protocols and technologies capable of providing a fund raising display 314 to the requestor 302 at the requesting computing device 304. Accordingly, the fund raising display 314 is not required to be a Web site presentation (e.g., based on HTML (hypertext markup language)), but can be based on other forms of UI and/or presentation software. The fund raising display 314 can also be based on UI, presentation software, network protocols, and related software and technologies to be developed in the future.

The network server 308 is a server computer, desktop computer, or other digital computing device suitable for executing the network information services software 318, the custom error page software 320, and the PFP application 323. In one embodiment, the functions of the network server 308 are handled by a network of multiple servers 308 with appropriate coordination, such as load balancing, among the servers. In one embodiment, the network server 308 is a Web server; the network information services software 318 is Microsoft® Internet Information Server (IIS) software; and the custom error page software 320 is a custom 404.asp file (Active Server Page). The PFP application 323 provides functions to support the access and processing of input received for a PFP (e.g., destination page 326), such as handling donations and pledges, and releasing pledges when an event is completed (as described elsewhere herein). The network server 308 includes a server processor 324 (e.g., digital microprocessor) that executes software instructions for the network information services software 318, custom error page 320, and PFP application 323 to perform the functions of the network information services software 318, custom error page 320, and PFP application 323 as described herein. The network information services software 318, custom error page 320, and PFP application 323 can support secure communications and protocols, such as those based on a secure hypertext transport protocol (e.g., HTTPS or S-HTTP). Also, the network server 308, the network information services software 318, the custom error page software 320, and PFP application 323 can be based on protocols, standards, network services, network products, and/or software languages to be developed in the future for networking, information services, and/or network error processing.

The page information database 310 is a database maintained on a data storage device storing digital data suitable for use by the network server 308. The page information database 310 is associated with the network server 308, and can be contained in the same physical box (e.g., cabinet), attached by a dedicated cable, or accessible over a network, such as the Internet or an SAN (storage area network). The database 310 is stored on a hard disk drive, read-write memory chips, or other suitable digital data storage device. The database 310 includes destination page information 326, which can include page code (e.g., HTML code) and/or page address information (e.g., Internet or Web address for a page). In some embodiments, the destination page information 326 is equivalent to (e.g., duplicate of) or provides access to the fund raising page 50 of a fund raising database 30. The network server 308 can also be associated with or able to access other databases than the page information database 310, such as the fund raising database 30 and/or other supplementary databases 32 (see FIG. 1).

The network 306 is a communications network suitable for providing a connection between the requesting computing device 304 and network server 308. The network 306 can be the Internet, LAN (local area network), WAN (wide area network), SAN (storage area network), MAN (metropolitan area network), wireless networks (e.g., Bluetooth or IEEE 802.11), mobile telephone networks, (e.g., cellular network based on CDMA (code division multiple access)), or other suitable networks, as well as network, communication technologies, and protocols to be developed in the future.

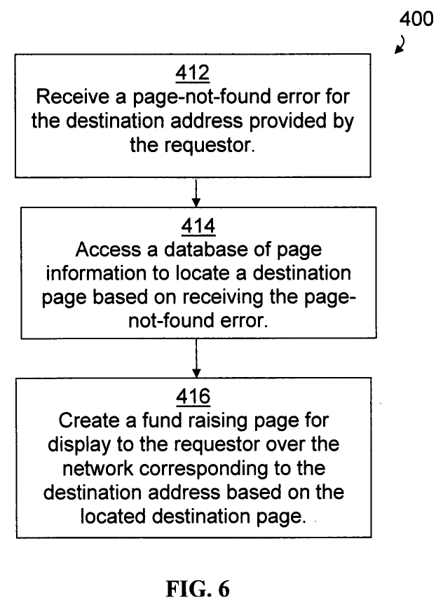

FIG. 6 is a flowchart of an address processing procedure 400, according to the principles of the invention. The procedure 400 first receives a page-not-found error 322 for the destination address 315 provided by the requestor 302 (step 412). For example, the requesting computing device 304 transfers the destination address 315 to the network server 308, and the network information services 318 produces a page-not-found error 322. Then, the procedure 400 accesses a database of page information 310 to locate a destination page 326 based on receiving the page-not-found error 322 (step 414). For example, the custom error page 320 processes the page-not-found error 322 to identify a destination page 326. The procedure 400 then creates a fund raising page 314 for display to the requestor 302 over the network 306 corresponding to the destination address 315 based on the located destination page 326 (step 416).

The approach of the invention ensures a scalable selection and assignment for a large number of page assignments on a home or top fund raising Web site that provides access to a large number of destination pages 326 (e.g., PFP's 50). These addresses are short address locators, which are also termed “short URL's” (short Uniform Resource Locators). These short address locators act as the destination address 315 for both charity landing pages and PFP's 50.

Typically, many conventional Web sites have URL's like http://www.somesite.com/default.asp?pageid=12345 (a hypothetical Web site). The approach of the invention creates a scalable use of the page-not-found mechanism used in some network information services 318. Consider two conventional options for the creation of memorable URL's for destination pages 326 (e.g., PFP pages 50) on a fund raising top or home Web site:

1. Add thousands of new virtual directories to each of the fund raising Web servers in real-time

2. Add thousands of new directories at the Web root, each with a default page that does a response. Redirect to an appropriate file, such as pfppagecodetemplate.asp with the correct parameter (such as pageid=12345).

Option 1 is typically limited by the network information services 318 metabase (typically a data file or database associated with the network information services 318). For example, in one conventional implementation, the metabase can only have one copy opened at a time, so only one fund-raiser (e.g. user 22) would be able to create a page 326 at once. Also, the metabase typically becomes unmanageable when it reaches more than a few thousand directories. Thus, there is a need to scale to thousands of instances or more of the destination pages 326.

Therefore, the approach of the invention pursues another option. If a requested folder or file does not exist in the network information services 318, then the network server 308 directs the request to its page-not-found page (e.g., 404 Page Not Found page). For example if the requester 302 makes a request 315 (e.g., http://www.somewebsite.co/somepape (a hypothetical Web site)), the result is a page not found message 322 (e.g., “404 Page not found”) because the folder/file does not exist.

The approach of the invention is to configure the error page that the network information services 318 serves when the requested file or directory does not exist; that is, create a custom error page 320 (e.g., custom 404.asp error page). The custom error page 320 (e.g., custom 404.asp page) examines the requested destination address 315 (e.g., URL, such as http://www.xyzfundraising.com/JaneSmith (a hypothetical Web site)), finds the corresponding PFP page record 326 in the database 310, and then creates the page for a fund raising display 314 at run-time each time the page is requested, including real-time sponsorship totals and a comprehensive sponsorship list. This approach of the invention allows many millions of short destination addresses (e.g., “short URL's”) such as http://www.xvzfundraising.com/JaneSmith (a hypothetical Web site) without exceeding the metabase and virtual directory limitations of some typical conventional network information services 318. The short destination addresses (e.g., “Short URL's”) are essentially virtual virtual directories. That is, they only exist in the page information databases 310 (e.g., SQL Server or other database) not as Web server folders. The approach of the invention also allows for greater portability and adaptation to various software systems; that is, the invention is not limited to specific (e.g., proprietary) network information services software 318.

Requestors 302 are not redirected to a page with a query string such as www.site.com/default.asp?pageid=12345 (a hypothetical query string). Requestors 302 of destination pages 326 (e.g., PFP pages 50) on a Web site that is configured according to the invention remain on the original URL (e.g. http://www.xyzfundraising.com/JaneSmith (a hypothetical Web site)).

This architecture of the invention also greatly improves search engine optimization for individual destination pages 326 (e.g., PFP pages 50), because conventional search engines typically do not follow server redirects such as from www.somesite.com/somepage (a hypothetical Web site) to www.somesite.com/somepage/?id=12345 (a hypothetical Web site)—with the latter URL displaying the page content.

The approach of the invention provides a technical system to provide customer-branded areas on a home or master fund raising Web site which are effectively “micro-websites” for the purpose of online fundraising. Through this system the home or master fund raising Web site is able to quickly configure and host many “micro sites” in a scalable manner by utilizing a database driven template.

This approach of the invention provides a system to provide customization of branding and content of multiple Web sites and sub-sites simultaneously. Each branding scheme (or skin or design) is given a unique ID (identifier). Files required by that skin (e.g., images, homepage, style sheets) are stored in a folder named with their skin's unique ID. Custom settings and content are stored in the database (e.g., an additional component of the fund raising database 30, and/or supplementary databases 32) under that skin's unique ID. When a browser (e.g., network browser 312) requests a page (e.g., requested destination address 315), from a combination of the URL and any unique ID's supplied as parameters, an algorithm determines which skin is the correct one to display. Settings for each skin determine the presence, or lack of, visual elements, and the horizontal and vertical measurements of those elements.

The approach of the invention also provides a pledge release system, which is an automated delayed transaction system for philanthropic purposes where a user (e.g., requestor 302) can promise (“pledge”) a donation tied to a designated charity/fundraiser/event combination (e.g., combination of records 70 as shown in FIG. 3), which is not released and subsequently processed/charged until an event completion date threshold has passed.

Sponsors (e.g., requestors 302 of a PFP) can elect to pledge a sponsorship amount to a fundraiser/friend or sponsor/donate immediately. The PFP application 323 provides this functionality by holding the pledge as an instruction to create a donation. The release of that instruction is automated and occurs when an event completion date of a PFP page (e.g., 50 or 326) is reached. In other words, the successful completion of an event by a participant causes the release of pledges made by sponsors to that participants' PFP (e.g., 50 or 326). In one embodiment, pledge release uses a combination of SQL Server Triggers and scheduled Windows Scripting Host tasks.

The code for the pledge release process is a method of the EventContribution class. An Event (e.g. running event such as a marathon) can have many PFP pages (e.g., 50 or 326), each for one fund raising participant. Each PFP page (e.g., 50 or 326) can have many event contributions (instances of sponsorship by requesters 302 of a PFP). An event contribution can be converted into a donation immediately or held as a pledge and converted to a donation at a later date—typically when the participant has completed the event.

In one embodiment, a pledge release script (e.g., the Automated Pledge Release VBS script) is executed by a Windows Server 2003 scheduled task. The code itself is interpreted and processed by the Windows Scripting Host (WSH) server application.

In one embodiment, a computer program product including a computer readable medium (e.g., one or more of DVD's, CD's, diskettes, tapes, and/or other suitable medium) provides software instructions for all or part of the software (e.g., fund raising application 40, vetting module 64, custom error page 320, PFP application 323, and/or other components). The computer program product can be installed from the computer readable medium by any suitable software installation procedure, as is well known in the art. In another embodiment, the computer readable medium is a computer program propagated signal product embodied on a propagated signal on a propagation medium (e.g., an electrical signal propagated over the Internet or other network, a radio wave, an infrared wave, an optical wave, or other electromagnetic wave) provides software instructions for all or part of the software (e.g., fund raising application 40, vetting module 64, custom error page 320, PFP application 323, and/or other components). Alternatively, the propagated signal is an analog carrier wave or a digital signal carried on the propagated medium. For example, the propagated signal can be a digitized signal propagated over the Internet or other network. In one embodiment, the propagated signal is a signal that is transmitted over the propagation medium over a period of time, such as the instruction for the software (e.g., fund raising application 40, vetting module 64, custom error page 320, PFP application 323, and/or other components) sent in segments (e.g., packets) over a network over a period typically of seconds, minutes, or longer.

Having described the preferred embodiments of the invention, it will now become apparent to one of skill in the arts that other embodiments incorporating the concepts may be used. It is felt, therefore, that these embodiments should not be limited to the disclosed embodiments but rather should be limited only by the spirit and scope of the following claims.

For example, the fund raising server 28 and the network server 308 can be the same computing device. Generally, the components and features of the invention as described herein (e.g., 24, 26, 28, 30, 32, 34, 36, 38, 40, 42, 44, 46, 48, 50, 52, 64, 66, 304, 308, 310, 312, 314, 316, 319, 320, 323, 324, and/or 326) can be combined or distributed without departing from the spirit of the invention, utilizing suitable networking and distributing computing technologies, including such technologies as may be developed in the future. For example, the approach of the invention can be implemented using one or more web servers, one or more application servers, and one or more data servers.

In another example, the functions and/or components of the invention as described herein (e.g., fund raising application 40, vetting module 64, custom error page 320, PFP application 323, and/or other components) can be implemented in a hardware device, such as an integrated circuit (IC), an ASIC (application specific integrated circuit), PLD (programmable logic device), or programmable gate array.

In another example, any of the software and/or hardware components described herein (e.g., 24, 26, 28, 30, 32, 34, 36, 38, 40, 42, 44, 46, 48, 50, 52, 64, 66, 304, 308, 310, 312, 314, 316, 319, 320, 323, 324, and/or 326) can support secure protocols, such as secure hypertext transport protocol (e.g., HTTPS or S-HTTP), secure socket layers (e.g., SSL), and other security technologies and protocols, including security technologies and protocols to be developed in the future.

What is claimed is:

1. A method for generating a page for charitable fund raising over a network at a fund raising server, the method comprising:
generating event information based on receiving from a user computing device a definition for a fund raising event created by a user;
determining organization information based on receiving from the user computing device a selection of a non-profit organization determined by the user;
generating a mapping of the event information to the organization information; and
creating a fund raising page accessible over the network based on user input and based on providing a link from the fund raising page to the mapping.

2. The method of claim 1, wherein the event information is an event record, the organization information is an organization record, and the mapping is a mapping record.

3. The method of claim 1, wherein determining the organization information comprises receiving a nomination for the selected nonprofit organization provided by the user and vetting the nonprofit organization based on the nomination.

4. The method of claim 3, wherein vetting the nonprofit organization comprises vetting an address for the selected nonprofit organization to insure delivery of event contributions to the selected nonprofit organization.

5. A method for generating a charitable fund raising page at a user computing device by a user over a network, the method comprising:
providing a definition for a fund raising event by the user at a user computing device to generate event information at a fund raising server;
providing a selection of a non-profit organization determined by the user at the user computing device to determine organization information at the fund raising server; and
providing user input to the fund raising server to generate a fund raising page accessible over the network based on a link from the fund raising page to a mapping of the event information to the organization information generated at the fund raising server.

6. The method of claim 5, wherein the event information is an event record, the organization information is an organization record; and the mapping is a mapping record.

7. The method of claim 5, providing a selection of a non-profit organization comprises providing a nomination for the selected nonprofit organization for vetting by the fund raising server to determine the organization information.

8. The method of claim 7, wherein the organization information comprises an address for the selected non-profit organization for vetting by the fund raising server to insure delivery of event contributions to the selected nonprofit organization.

9. A method for processing a destination address for charitable fund raising over a network by a fund raising server and for access at a requesting computing device by a requestor providing the destination address, the method comprising:
receiving at the fund raising server a page-not-found error for the destination address provided by the requestor;
accessing a database of page information to locate a destination page based on receiving the page-not-found error; and
creating a fund raising page for display at the requesting computer device to the requestor over the network from the fund raising server corresponding to the destination address based on the located destination page.

10. The method of claim 9, wherein the page-not-found error comprises a hypertext transfer protocol not-found status code.
